(19) United States
(12) Patent Application Publication
(10) Pub. No.: US 2017/0091967 A1
(43) Pub. Date: Mar. 30, 2017

(54) ANIMATING TRANSITIONS TO CIRCULAR DATA VISUALIZATIONS

(71) Applicant: SAP SE, Walldorf (DE)

(72) Inventor: Konrad Roepke, Berlin (DE)

(73) Assignee: SAP SE, Walldorf (DE)

(21) Appl. No.: 14/865,622

(22) Filed: Sep. 25, 2015

(51) Int. Cl. G06T 11/20; G06T 13/80

(52) U.S. Cl. CPC G06T 11/206; G06T 13/80

(57) ABSTRACT

Examples of animating a transition between a first data visualization and an alternative, circular data visualization are provided herein. A first data visualization representing data in a dataset can be generated. The first data visualization has at least one of a horizontal axis or a vertical axis. An instruction can be received to represent the data in the dataset using a circular visualization type such as a ring visualization, pie chart, or donut chart. In response to receiving the instruction, an alternative data visualization, of the circular visualization type, can be generated by animating a transition between the first data visualization and the alternative data visualization.

### BACKGROUND

As computer hardware and software have become increasingly advanced, the amount of data collected about a variety of things has grown substantially. Analytics software has been increasingly used to analyze and interpret such large amounts of data. Visualization applications, for example, can provide graphical representations of different aspects of data to allow a user to understand complicated relationships. Even with the tools available in conventional visualization applications, however, it can sometimes be difficult to easily and clearly view different aspects of a dataset.

### BRIEF DESCRIPTION OF THE DRAWINGS

FIG. 1 is an example system configured to animate a transition to a circular data visualization.

FIG. 2 illustrates an example method for generating an alternative data visualization of a circular visualization type based on an initial data visualization.

FIG. 3 is an example user interface of a visualization application in which a transition can be animated from an initial data visualization, shown as a column chart, to a circular data visualization.

FIG. 4 shows an example of the user interface of FIG. 3 after an animated transition to a circular data visualization.

FIG. 5 shows example stages in an animated transition to a ring visualization in which an axis curves down to form a perimeter of the ring visualization.

FIG. 6 shows example stages in an animated transition to a ring visualization in which an axis curves up to form a perimeter of the ring visualization.

FIG. 7 shows example stages in an animated transition to a pie chart in which an axis curves up to form a perimeter of the pie chart.

FIG. 8 shows beginning and end stages in an animated transition from a row chart to a ring visualization in which an axis curves up to form a perimeter of the ring visualization.

FIG. 9 shows an example result of an animated transition from a column chart to a ring visualization.

FIG. 10 illustrates an example method for animating a transition to a ring visualization from an initial data visualization.

FIG. 11 is a diagram illustrating a generalized implementation environment in which some described examples can be implemented.

### DETAILED DESCRIPTION

The examples described herein generally allow conversion between an initial data visualization (e.g., a column or row chart) and an alternative data visualization of a circular visualization type (e.g., a ring visualization or pie chart). A data visualization is a graphical representation of data, such as a chart, graph, or table. Data visualizations have a data visualization type, which can be, for example, a column chart, a stacked column chart, a row chart, a stacked row chart, a three-dimensional column chart, a three-dimensional row chart, a line chart, an area chart, a pie chart, a donut chart, or a ring visualization. Data visualizations provide easy-to-understand, graphical representations of data that are useful for data analysis. In typical conventional data visualization applications, it can be difficult and confusing to switch between different representations of data.

In the described examples, a user can interact with a data visualization and easily initiate an animated transition from the data visualization to an alternative data visualization of a circular visualization type. As used herein, a “circular” visualization type refers to a data visualization in which data is represented using a circular chart shape. Examples of circular data visualizations include ring visualizations, pie charts, and donut charts. Different data visualizations represent data in different ways, and being able to quickly and easily switch between data visualizations of different types enables a user to understand data from multiple perspectives.

As an example, if a user were interested in export data for various countries, the user might request a column chart indicating a currency value of exports along the y-axis and the various countries along the x-axis. While the column chart does provide some information (value of exports), alternative visualization types can illustrate other aspects of the data. A ring visualization, for example, illustrates interrelationships that are not typically apparent from inspecting a column chart. Continuing the above example, the column chart can be transitioned to a ring visualization in which the various countries are represented around the perimeter of a ring. For a country of interest, a line or arc is generated that connects the country of interest to other countries that receive the country of interest's exports, thus illustrating trade relationships between countries that were not apparent from the column chart. As a specific example, the x-axis along which the various countries are represented in the column chart can be formed into the perimeter of the ring visualization through an animated transition.

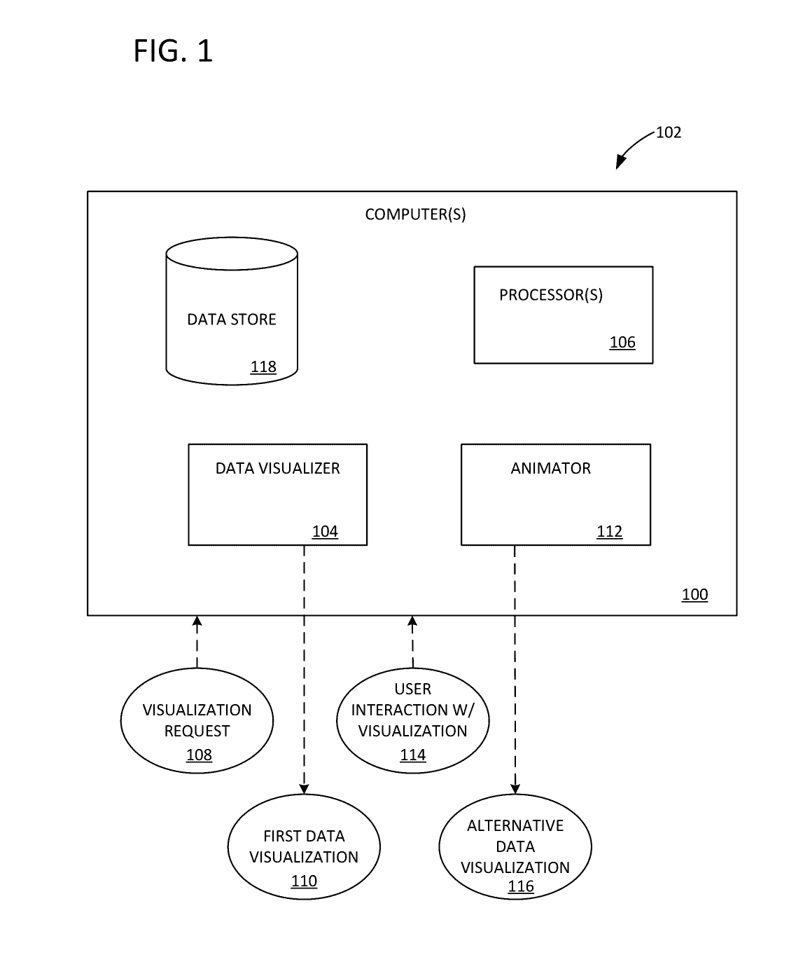

The described examples are an improvement to data visualization technology that allow a user to quickly change the way in which data is represented without having to waste the time and computing resources that would be required to maintain and open two separate visualization files to view both types of visualizations. Examples are described below with reference to FIGS. 1-11.

FIG. 1 illustrates one or more computer(s) 100 implementing a system 102. System 102 includes a data visualizer 104 that is configured to, by one or more processors 106, and in response to a visualization request 108, generate a first data visualization 110. First data visualization 110 represents data in a dataset and can be a plot of one or more dimensions versus one or more measures. The terms “measures” and “dimensions” are well-known in analytics. As an example, in a visualization depicting population by city, the cities (x-axis) are dimensions and population (y-axis) is a measure. “Dimensions” used in this context does not refer to a geometric dimension such as a measurement of height, width, or length, or a state of being one-dimensional, two-dimensional (2D), or three-dimensional (3D).

The data in the dataset represented by first data visualization 110 can be specified, for example, in visualization request 108. Visualization request 108 can be specified by a user through a data visualization application or other software application having data visualization functionality. Such applications can be web applications provided over the Internet or can be installed on local computers or server computers accessible over a local area network (LAN) or other network. In some examples, data visualizer 104 and other components of system 102 are part of a data visualization application.

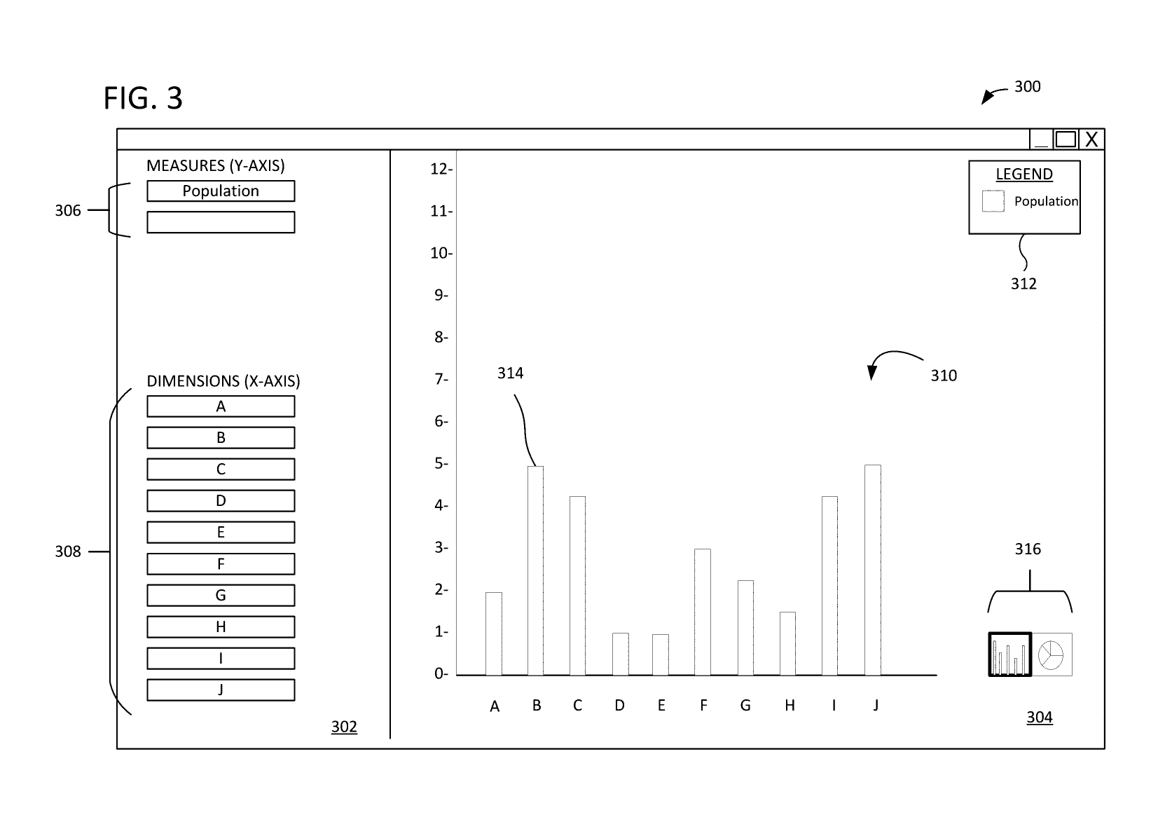

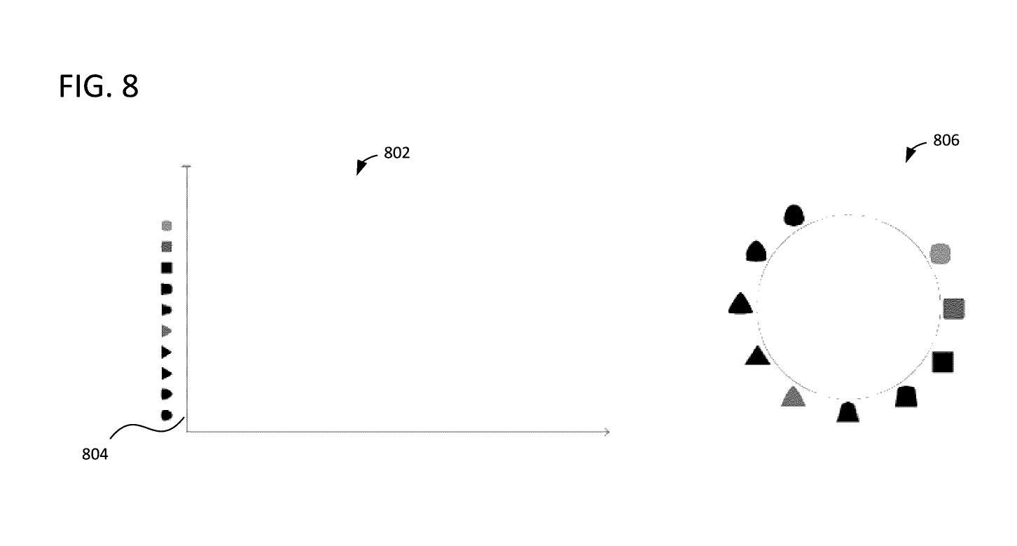

First data visualization 110 has at least one of a horizontal axis or a vertical axis. First data visualization 110 can be, for example, a column chart, a stacked column chart, a row chart, a stacked row chart, a three-dimensional column chart, a three-dimensional row chart, a line chart, or an area chart. Examples of first data visualization 110 are illustrated in FIGS. 3 and 8.

An animator 112 is configured to, by the one or more processors 106, animate, in response to a received instruction based on a user interaction 114 with first data visualization 110, a transition between first data visualization 110 and an alternative data visualization 116 of a circular visualization type. Example circular visualization types include a ring chart, pie chart, and donut chart. User interaction 114 can include a variety of actions, including mouse, hover, touch or other interactions with a visualization type control button, data label, axis, or displayed portion of first data visualization 110. Animator 112 can animate the transition using, for example Data Driven Documents (D3), Adobe Flash, HTML, or other language or script.

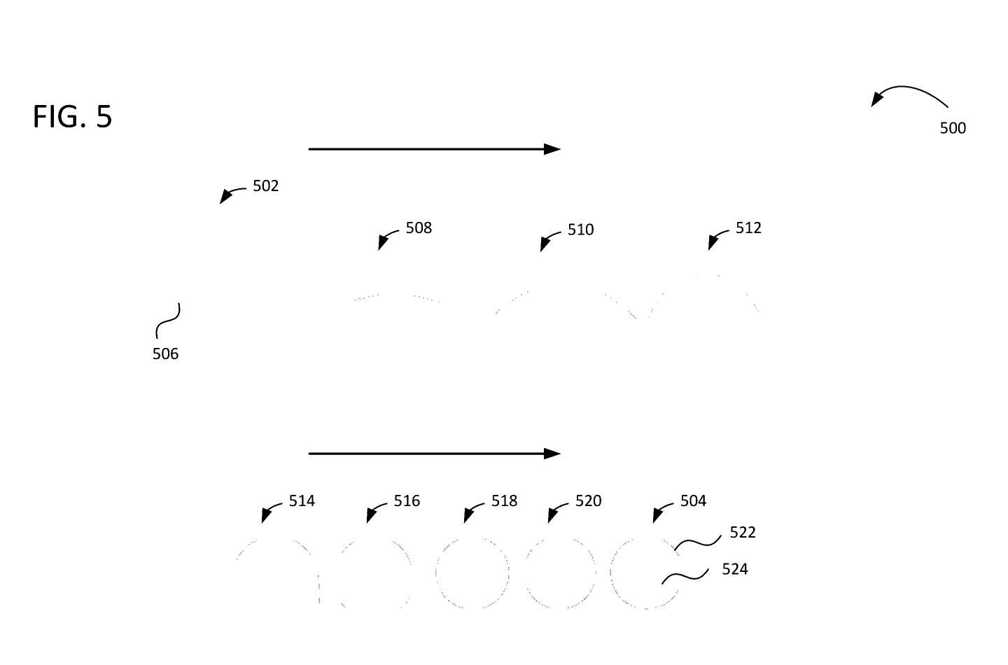

The alternative data visualization of the circular visualization type can comprise a perimeter, and in some examples, animator 112 is configured to animate the transition by bending or otherwise forming the horizontal axis or the vertical axis of first data visualization 110 into the perimeter of alternative data visualization 116. Examples of forming the axis into the perimeter of alternative data visualization 116 (or into a circle that is part of alternative data visualization 116) are illustrated in FIGS. 5-7. In some examples, the axis is bent into a circle that forms the perimeter of (or otherwise forms part of) alternative data visualization 116 by determining an extent of the horizontal axis or the vertical axis of first data visualization 110 along which one or more dimensions are represented, the extent having a start point and an end point, and bringing the start point and the end point together. In some examples, user interaction 114 is a touch gesture or mouse interaction pulling or pushing up, down, left, or right on (or otherwise deforming) the horizontal axis or the vertical axis of first data visualization 110, and user interaction 114 initiates the instruction to animate the transition.

In some examples, animator 112 is also configured to save alternative data visualization 116 in association with a visualization file (not shown) corresponding to first data visualization 110. The visualization file can be saved, for example, in data store 118. The visualization file can also be referred to as a “chart” or a “report.” Alternative visualization 116 can be saved as a separate file (visualization file or other file) linked by a reference in the visualization file to the location or file name of the separate file or can be saved as part of the visualization file itself. The dataset(s) being visualized in first data visualization 110 can also be stored in data store 118. Data store 118 can be a database, such as an in-memory columnar relational database, and can be located, in some examples, external to computer(s) 100.

In FIG. 1, the arrows indicating inputs and outputs of system 102 are only an example. Any of the components of system 102 can be in communication with any other components. In examples in which system 102 is implemented on multiple computer(s) 100 (e.g. multiple server computers), computers 100 can be in communication via a network (not shown). The network can be the Internet, a LAN, a wireless local area network (WLAN), a wide area network (WAN), or other type of network, wired or wireless. Visualization request 108 and an indication of user interaction 114 can be received via the network, and first data visualization 110 and alternative data visualization 116 can be provided via the network.

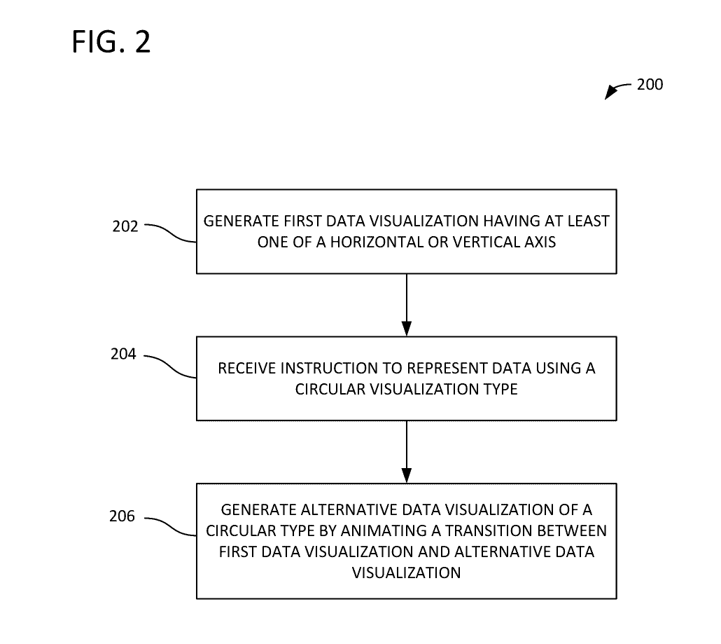

FIG. 2 illustrates a method 200 for generating an alternative data visualization of a circular visualization type based on an initial data visualization. In process block 202, a first data visualization representing data in a dataset is generated. The first visualization has at least one of a horizontal axis or a vertical axis. The first visualization can be, for example, a column chart, a stacked column chart, a row chart, a stacked row chart, a three-dimensional column chart, a three-dimensional row chart, a line chart, or an area chart. In process block 204, an instruction is received to represent the data in the dataset using a circular visualization type. The circular visualization type can be one of a ring chart, a pie chart, or a donut chart. The received instruction can indicate a received user touch or hover gesture or mouse interaction on the horizontal axis or the vertical axis. In some examples, the received user touch or hover gesture or mouse interaction includes pulling up or down on the horizontal axis or left or right on the vertical axis.

In process block 206, an alternative data visualization is generated in response to receiving the instruction by animating a transition between the first data visualization and the alternative data visualization. The alternative data visualization is of a circular visualization type.

FIG. 3 illustrates an example user interface 300 of a visualization application. Interface 300 includes a data selection area 302 and a data visualization display area 304. Data selection area 302 includes a group of measures 306 and a group of dimensions 308. Group of measures 306 includes “Population.” Group of dimensions 308 includes countries “A,” “B,” “C,” “D,” “E,” etc. The measures included in group of measures 306 and the dimensions included in group of dimensions 308 can, for example, be selected by a user in order to create an initial data visualization 310.

Initial data visualization 310 is displayed in data visualization display area 304, along with a legend 312 corresponding to the measures shown in group of measures 306. Initial data visualization 310 is a column chart in which a single measure is represented for each dimension of group of dimensions 308 as a single column For example, column 314 illustrates the quantities of the measure “Population” for country “B.”

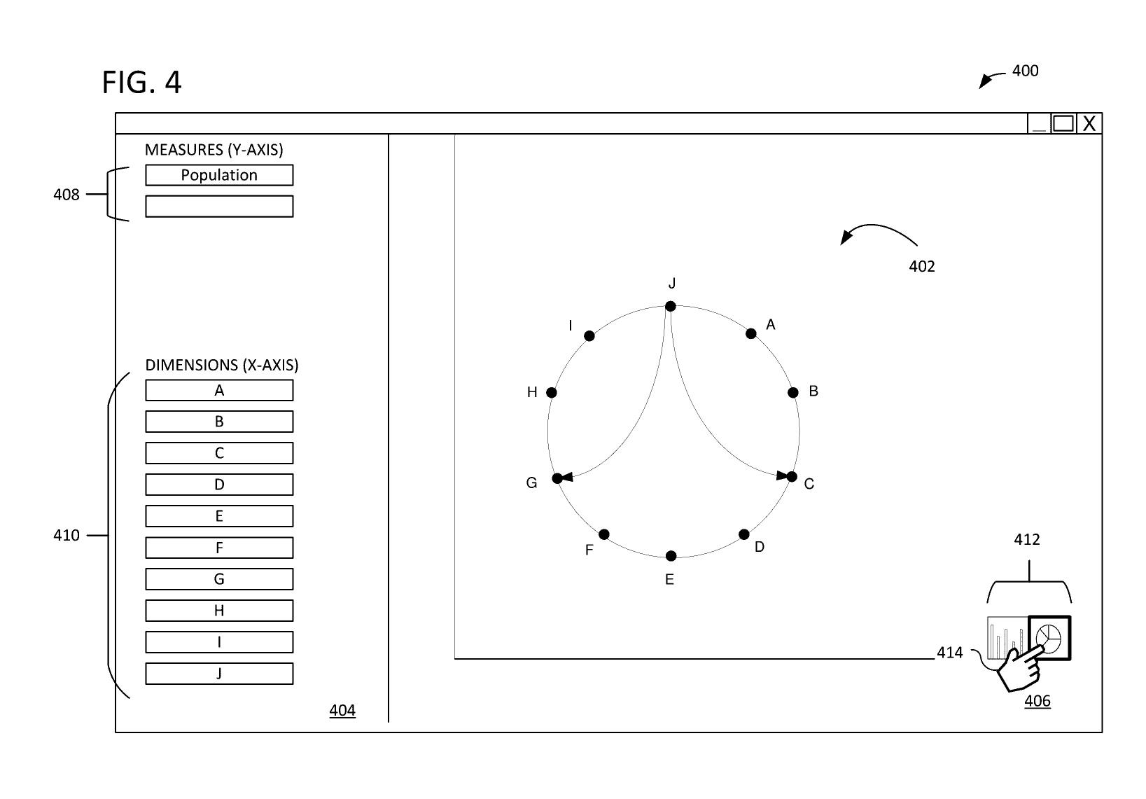

Visualization type control 316 allows a user to generate an alternative data visualization of a circular type (e.g., as shown in FIG. 4) by animating a transition from initial data visualization 310 to the alternative data visualization. Visualization type control 316 is shown as a toggle control in which a user can select between a column/row chart type visualization and a circular visualization such as a ring visualization or pie chart. Other types of visualization type controls are also contemplated. Example animations are depicted in FIGS. 5-7.

A user can use a mouse or other input device, touch input, hover input, or other input to select visualization type control 316. Various other options for initiating an animated transition to an alternative data visualization are also contemplated. Examples include: a visualization type menu or menu option that can be selected; right-clicking, holding shift or control while clicking on initial data visualization 310; use of a function key, selecting or dragging an axis, or other actions or combination of actions; etc.

FIG. 4 illustrates user interface 400, which is similar to the user interface 300 of FIG. 3 but shows an alternative data visualization 402. Interface 400 includes a data selection area 404 and a data visualization display area 406. Group of measures 408 and group of dimensions 410 are the same as in FIG. 3. In FIG. 4, a user has interacted with visualization type control 412. The interaction is represented by pointer icon 414. Alternative data visualization 402 is generated in response to the interaction with the visualization type control 412. Example animated transitions from the initial data visualization to alternative data visualization 402 are illustrated in FIGS. 5-7. Although the circular visualization icon shown on visualization type control 412 is a pie chart, the visualization application can be configured to animate a transition to any circular visualization type. In some examples, interacting with the circular visualization icon causes a menu or list (not shown) to be displayed listing multiple types of circular visualizations for selection. In some examples, a user can set a preference for a certain type of circular visualization (and/or for the type of circular visualization that appears on the icon in visualization type control 412).

Alternative data visualization 402 is a ring visualization (also referred to as a ring chart). A ring visualization illustrates interrelationships. In alternative data visualization 402, each of the countries A-J that were listed as dimensions along the x-axis in FIG. 3 are represented as dots around the perimeter of the circle in alternative data visualization 402. Lines or arcs connecting the letters can show interrelationships. For example, initial data visualization 310 of FIG. 3 is a plot of population of the listed countries. Alternative data visualization 402 can illustrate ways in which the populations of the listed countries are interrelated, such as immigration and emigration. As shown in FIG. 4, country J has a net migration out to countries C and G. Other lines or arcs can also be added to indicate in migration, citizens of other countries that claim descent from country J, etc. Such information is not easily inferred from initial data visualization 310 of FIG. 3. In some examples, various additional interfaces are shown that allow a user to select the type of interrelationship that is illustrated in alternative data visualization 402.

FIG. 5 illustrates example stages 500 in an animated transition from a column chart 502 to a ring visualization 504. During the animated transition, the x-axis 506 of column chart 502 is bent downwards (or pulled upwards) through stages 508, 510, 512, 514, 516, 518, and 520 until x-axis 506 forms the perimeter 522 of ring visualization 504. The animated transition illustrated in FIG. 5 can be performed to transition, for example, between initial data visualization 310 of FIG. 3 and alternative data visualization 402 of FIG. 4. As shown in FIG. 5, the portion of x-axis 506 that is formed into perimeter 522 is the portion across which data is represented. That is, while an axis can extend beyond the data illustrated in a visualization, in some examples, the portion of the axis that is formed into a circle that is part of the circular data visualization is the portion that is co-extensive with the illustrated data. The animated transition in FIG. 5 can be initiated, for example, by selecting a visualization type control or by a user dragging (pushing or pulling) x-axis 506 upwards until a threshold (e.g., a distance, time, or velocity threshold) has been exceeded. Animating the transition can also include generating interrelationship paths, such as interrelationship path 524, connecting at least some of the measures or dimensions represented along the perimeter of the ring visualization.

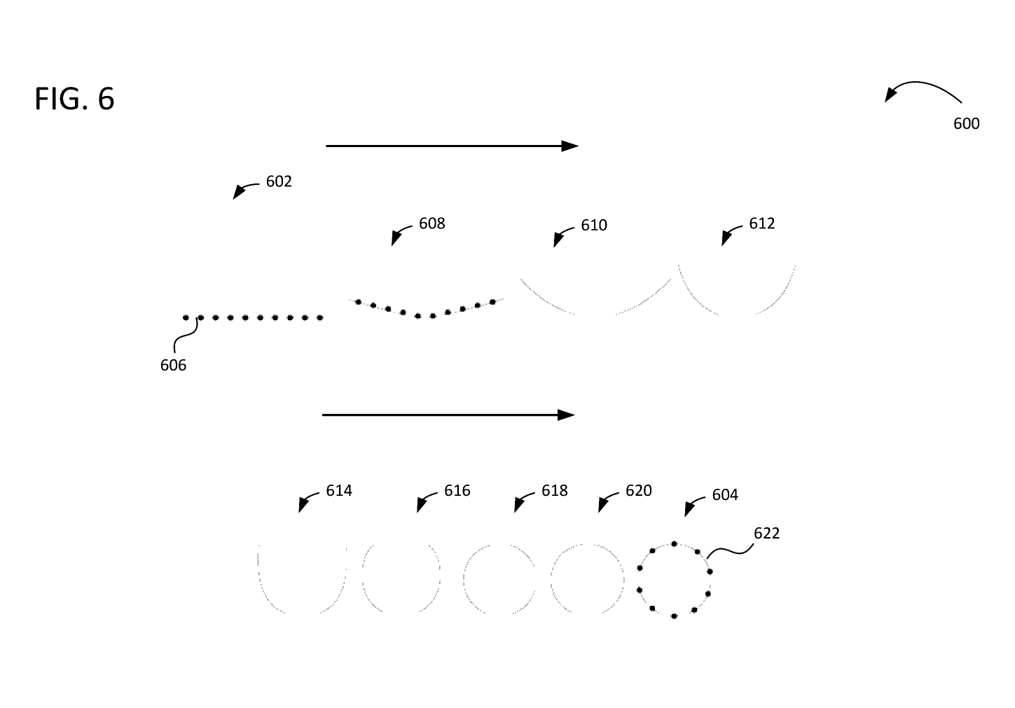

FIG. 6 illustrates example stages 600 in an animated transition from a column chart 602 to a ring visualization 604. During the animated transition, the x-axis 606 of column chart 602 is bent upwards (or pulled downwards from the center) through stages 608, 610, 612, 614, 616, 618, and 620 until x-axis 606 forms the perimeter 622 of ring visualization 604. Although x-axis 606 is shown as forming the perimeter 622 of ring visualization 604, in some examples, x-axis 606 forms a circle that while not a perimeter around which data is represented is still a part of the circular visualization (e.g., an inner or outer concentric circle).

In some examples, a dimension location point along the horizontal or vertical axis is determined for the respective dimensions. This is illustrated in FIG. 6 by the dots at the base of each column in column chart 602. As the transition is animated, the relative distance (e.g., equal spacing) between the dimension location points is maintained along the perimeter of ring visualization 604. The animated transition in FIG. 6 can be initiated, for example, by selecting a visualization type control or by a user dragging (pushing or pulling) x-axis 606 downwards until a threshold (e.g., a distance, time, or velocity threshold) has been exceeded. Similarly, an animated transition from ring visualization 604 back to column chart 602 can be initiated by selection of the visualization type control or by a user dragging (pushing or pulling) the perimeter 622 of ring visualization 604 until a threshold (e.g., a distance, time, or velocity threshold) has been exceeded. The threshold for transitioning from column chart 602 can be different from the threshold transitioning from ring visualization 604.

In some examples, labels or symbols associated with the columns (dimensions) of column chart 602 are animated to a position near the corresponding dimension location points such that the labels or symbols appear around the perimeter of ring visualization 604. Although column charts are shown in FIGS. 5 and 6, the y-axis of a row chart can also be formed into a perimeter of a circular visualization, and animating such a transition can be initiated by a user pushing or pulling on the y-axis to the left or to the right.

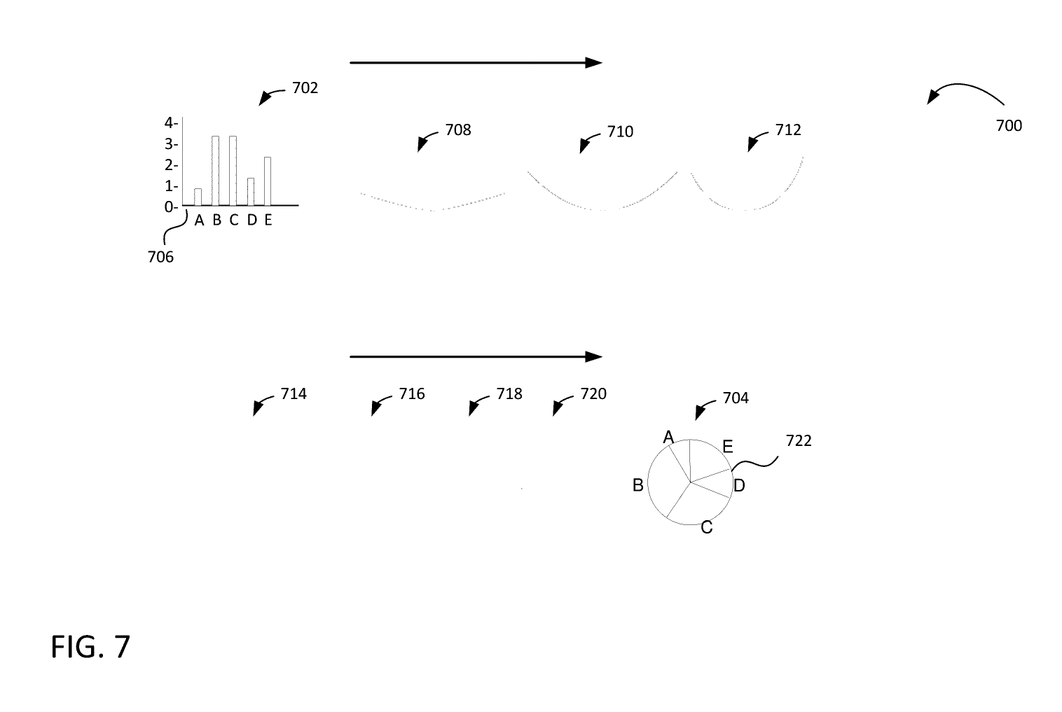

FIG. 7 illustrates example stages 700 in an animated transition from a column chart 702 to a pie chart 704. During the animated transition, the x-axis 706 of column chart 702 is bent upwards through stages 708, 710, 712, 714, 716, 718, and 720 until x-axis 706 forms the perimeter 722 of pie chart 702.

FIG. 8 illustrates a row chart 802 in which the y-axis 804 has been formed, through an animated transition similar to FIGS. 5-7, into a ring visualization 806. The symbols corresponding to the respective rows in row chart 802 have also been transitioned to ring visualization 806.

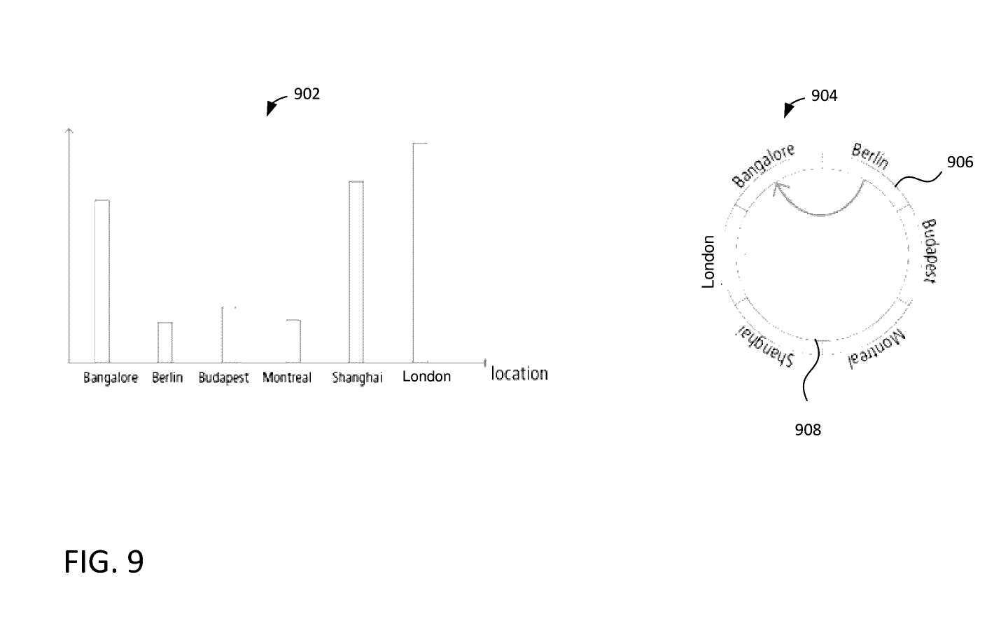

FIG. 9 illustrates a column chart 902 having different cities as dimensions along the x-axis. Through an animated transition, the x-axis has been formed into a ring visualization 904 that shows the interrelationships between the cities (migration, worker transfers, communication volume, etc.). Ring visualization 904 has both an outer perimeter 906 and an inner perimeter 908. Either outer perimeter 906 or inner perimeter 908 can be the circle into which the x-axis of column chart 902 was formed.

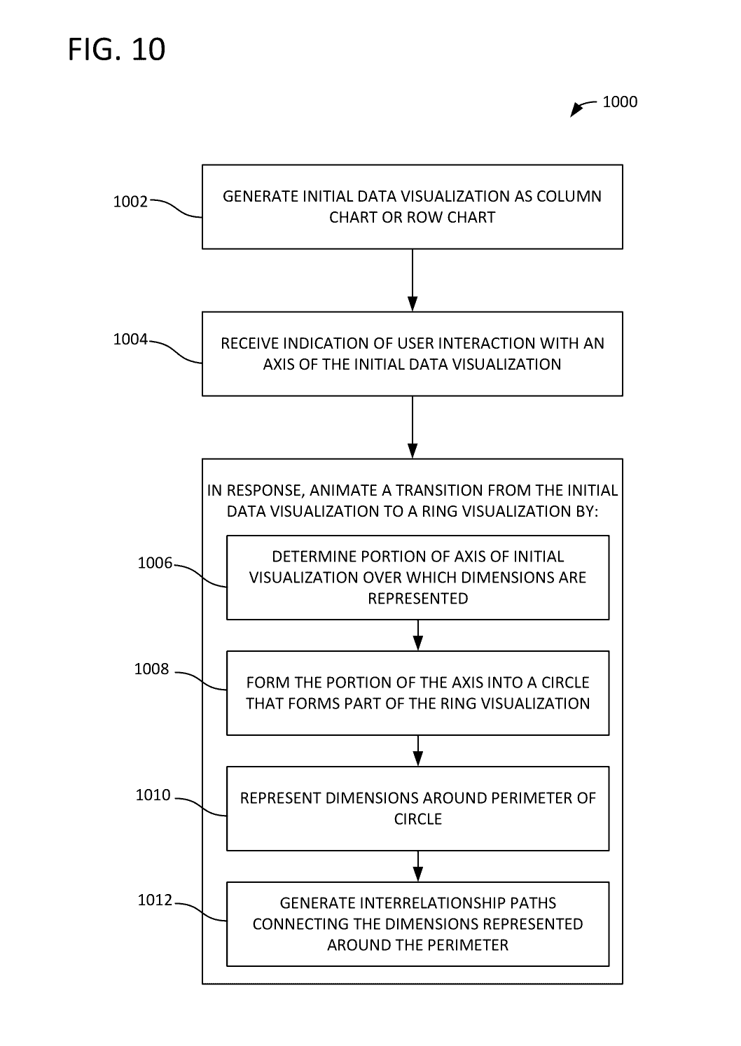

FIG. 10 illustrates a method 1000 of animating a transition to a ring visualization from an initial data visualization. In process block 1002, an initial data visualization is generated representing data in a dataset as a plot of measures and dimensions, the initial data visualization being one of a column chart or a row chart. In process block 1004, an indication of a user interaction with an axis of the initial data visualization is received. The dimensions of the plot are represented along the axis. The user interaction can be, for example, a pushing or pulling of the axis up, down, left, or right. In response to receiving the indication, a transition is animated from the initial data visualization to a ring visualization through process blocks 1006, 1008, 1010, and 1012. In process block 1006, a portion of the axis of the initial data visualization over which the dimensions are represented is determined In process block 1008, the portion of the axis of the initial data visualization is formed into a circle that forms a part of the ring visualization. The dimensions illustrated in the initial data visualization are represented around the perimeter of the circle in process block 1010. In process block 1012, interrelationship paths are generated that connect at least some of the dimensions represented around the perimeter of the circle.

In some examples, method 1000 further comprises receiving an indication of a user interaction with the perimeter of the circle that forms part of the ring visualization, and, in response to receiving the indication of the user interaction with the perimeter, animating a transition from the ring visualization back to the initial data visualization.

### Examples of Computing Environments

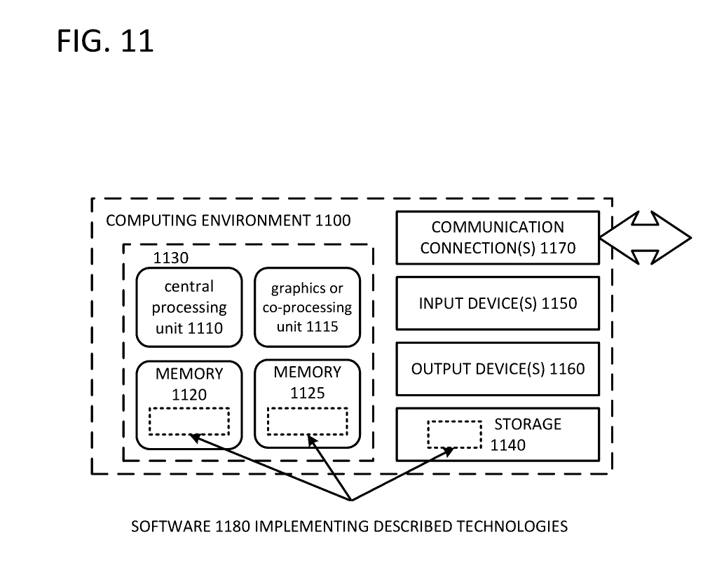

FIG. 11 depicts a generalized example of a suitable computing environment 1100 in which the described innovations may be implemented. The computing environment 1100 is not intended to suggest any limitation as to scope of use or functionality, as the innovations may be implemented in diverse general-purpose or special-purpose computing systems. For example, the computing environment 1100 can be any of a variety of computing devices (e.g., desktop computer, laptop computer, server computer, tablet computer, media player, gaming system, mobile device, etc.)

With reference to FIG. 11, the computing environment 1100 includes one or more processing units 1110, 1115 and memory 1120, 1125. In FIG. 11, this basic configuration 1130 is included within a dashed line. The processing units 1110, 1115 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power.

For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s). The memory 1120, 1125 stores software 1180 implementing one or more innovations described herein, in the form of computer-executable instructions suitable for execution by the processing unit(s). For example, memory 1120 and 1125 and software 1180 can store computer-executable instructions for animating a transition from an initial data visualization to an alternative, circular data visualization. Computing environment 1100 can include data visualizer 104, processor(s) 106, animator 112, and/or data store 118 of FIG. 1.

A computing system may have additional features. For example, the computing environment 1100 includes storage 1140, one or more input devices 1150, one or more output devices 1160, and one or more communication connections 1170. An interconnection mechanism (not shown) such as a bus, controller, or network interconnects the components of the computing environment 1100. Typically, operating system software (not shown) provides an operating environment for other software executing in the computing environment 1100, and coordinates activities of the components of the computing environment 1100.

The tangible storage 1140 may be removable or non-removable, and includes magnetic disks, magnetic tapes or cassettes, CD-ROMs, DVDs, or any other medium which can be used to store information and which can be accessed within the computing environment 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing environment 1100. For video encoding, the input device(s) 1150 may be a camera, video card, TV tuner card, or similar device that accepts video input in analog or digital form, or a CD-ROM or CD-RW that reads video samples into the computing environment 1100. The output device(s) 1160 may be a display, printer, speaker, CD-writer, or another device that provides output from the computing environment 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

What is claimed is:

1. One or more computer-readable storage media storing computer-executable instructions for:
generating a first data visualization representing data in a dataset, the first visualization having at least one of a horizontal axis or a vertical axis;
receiving an instruction to represent the data in the dataset using a circular visualization type; and
in response to receiving the instruction, generating an alternative data visualization, of the circular visualization type, that represents the data in the dataset by animating a transition between the first data visualization and the alternative data visualization.

2. The one or more computer-readable storage media of claim 1, wherein the circular visualization type is one of a ring visualization, a pie chart, or a donut chart.

3. The one or more computer-readable storage media of claim 1, wherein the first visualization is one of: a column chart, a stacked column chart, a row chart, a stacked row chart, a three-dimensional column chart, a three-dimensional row chart, a line chart, or an area chart.

4. The one or more computer-readable storage media of claim 1, wherein the alternative data visualization of the circular visualization type comprises a perimeter, and wherein animating the transition comprises forming one of the horizontal axis or the vertical axis of the first visualization into the perimeter of the alternative data visualization of the circular visualization type.

5. The one or more computer-readable storage media of claim 4, wherein the first data visualization is a plot of one or more dimensions versus one or more measures, and wherein forming the one of the horizontal axis or the vertical axis of the first visualization into the perimeter of the alternative data visualization comprises:
determining, for respective dimensions of the one or more dimensions, a dimension location point along the one of the horizontal axis of the vertical axis; and
maintaining a relative distance between the dimension location points along the perimeter of the alternative data visualization.

6. The one or more computer-readable storage media of claim 1, wherein the received instruction indicates a received user selection of a visualization type control.

7. The one or more computer-readable storage media of claim 1, wherein the received instruction indicates a received user touch or hover gesture or mouse interaction on at least one of the horizontal axis or the vertical axis.

8. The one or more computer-readable storage media of claim 7, wherein the received user touch or hover gesture or mouse interaction comprises pulling up or down on the at least one of the horizontal axis or the vertical axis.

9. The computer-readable media of claim 1, wherein the first data visualization is a plot of dimensions versus measures, and wherein the alternative data visualization illustrates interrelationships between or among dimensions.

10. One or more computing devices comprising:
one or more processors;
a data visualizer configured to, by the one or more processors:
generate a first data visualization representing data in a dataset as a plot of one or more dimensions versus one or more measures, the first data visualization having at least one of a horizontal axis or a vertical axis; and
an animator configured to, by the one or more processors:
animate, in response to a received instruction, a transition between the first data visualization and an alternative data visualization of a circular visualization type.

11. The one or more computing devices of claim 10, wherein the circular visualization type is a ring visualization in which the one or more measures or the one or more dimensions are represented along a perimeter of the ring visualization.

12. The one or more computing devices of claim 11, wherein animating the transition comprises generating interrelationship paths connecting at least some of the one or more measures or the one or more dimensions represented along the perimeter of the ring visualization.

13. The one or more computing devices of claim 10, wherein the first visualization is one of: a column chart, a stacked column chart, a row chart, a stacked row chart, a three-dimensional column chart, a three-dimensional row chart, a line chart, or an area chart.

14. The one or more computing devices of claim 10, wherein animating the transition comprises bending one of the horizontal axis or the vertical axis of the first visualization into a circle that forms a portion of the alternative data visualization.

15. The one or more computing devices of claim 14, wherein the bending comprises:
determining an extent of either the horizontal axis or the vertical axis of the first data visualization along which the one or more dimensions are represented, the extent having a start point and an end point; and
bringing the start point and the end point together.

16. The one or more computing devices of claim 10, wherein the received instruction indicates a received user touch gesture or mouse interaction pulling up or down on the at least one of the horizontal axis or the vertical axis.

17. A computer-implemented method comprising:
generating an initial data visualization representing data in a dataset as a plot of measures and dimensions, the initial data visualization being one of a column chart or a row chart;
receiving an indication of a user interaction with an axis of the initial data visualization, wherein the dimensions of the plot are represented along the axis; and
in response to receiving the indication, animating a transition from the initial data visualization to a ring visualization by:
determining a portion of the axis of the initial data visualization over which the dimensions are represented,
forming the portion of the axis of the initial data visualization into a circle that forms a part of the ring visualization;
representing the dimensions around the perimeter of the circle; and
generating interrelationship paths connecting at least some of the dimensions represented around the perimeter of the circle.

18. The computer-implemented method of claim 17, wherein the initial data visualization includes at least one of symbols or labels corresponding to the respective dimensions, and wherein animating the transition further comprises moving the symbols or labels to positions around the perimeter of the circle based on the dimensions to which the respective symbols or labels correspond.

19. The computer-implemented method of claim 17, wherein when the axis is a horizontal axis, the user interaction with the axis comprises pushing or pulling up or down on the axis, and wherein when the axis is a vertical axis, the user interaction with the axis comprises pushing or pulling left or right on the axis.

20. The computer-implemented method of claim 17, further comprising:
receiving an indication of a user interaction with the perimeter of the circle that forms part of the ring visualization; and
in response to receiving the indication of the user interaction with the perimeter, animating a transition from the ring visualization back to the initial data visualization.
